(19) United States
(12) Patent Application Publication
(10) Pub. No.: US 2012/0229267 A1
(43) Pub. Date: Sep. 13, 2012

(54) VEHICLE EXISTENCE NOTIFICATION APPARATUS

(75) Inventor: Toshiaki Nakayama, Miyoshi-city (JP)

(73) Assignee: DENSO CORPORAITON, Kariya-city (JP)

(21) Appl. No.: 13/396,813

(22) Filed: Feb. 15, 2012

(30) Foreign Application Priority Data
Mar. 7, 2011 (JP) 2011-48874

(51) Int. Cl. B60Q 1/50

(52) U.S. Cl. 340/463

(57) ABSTRACT

A vehicle existence notification apparatus disposed in a vehicle includes a sound wave generation unit that transmits a sound wave to an area outside of the vehicle, and a control unit that controls the sound wave generation unit to generate a notification sound. The control unit generates a stopping-vehicle notification sound for notifying existence of a stop condition of the vehicle, and generates a moving-vehicle notification sound for notifying existence of a traveling condition of the vehicle. The simulated idling sound enables a pedestrian to recognize the vehicle when the vehicle is in a stop condition, and the simulated moving-vehicle sound enables the pedestrian to recognize the vehicle when the vehicle is in a traveling condition.

### CROSS REFERENCE TO RELATED APPLICATION

The present application is based on and claims the benefit of priority of Japanese Patent Application No. 2011-48874, filed on Mar. 7, 2011, the disclosure of which is incorporated herein by reference.

### TECHNICAL FIELD

The present disclosure generally relates to a vehicle existence notification apparatus that notifies to an area outside of a vehicle the existence of the vehicle by using a notification sound.

### BACKGROUND

In general, a pedestrian, which may include a walker that may be visually impaired, may recognize the presence of a vehicle by listening to an engine sound of the vehicle. However, when the vehicle is a quiet vehicle that generates very little to no traveling or idling sound, such as an electric vehicle that is powered by a battery or fuel cell technology vehicle, it may be difficult for a pedestrian to recognize the presence of the vehicle by listening to the sounds generated by the vehicle, because of the lack of sounds produced by such vehicle. A warning device that outputs a sound to notify others in the vicinity of the vehicle is disclosed in Japanese Patent Laid-Open No. 2005-289175 (JP '175).

Further, it may also be difficult for the pedestrian to recognize the presence of the vehicle when the vehicle is a conventional vehicle with an engine, and is equipped with an idling stop function that stops the engine during a stop condition of the vehicle.

Furthermore, even when the engine-powered vehicle is not equipped with such idling stop function, there might be a case that the engine sound is quiet enough to be buried in the background noise or the like, thereby making it difficult for the pedestrian to recognize the engine-powered vehicle.

In summary, a pedestrian may:

(i) recognize the presence of a stopped vehicle by an idling sound,

(ii) recognize the presence of a moving vehicle by a moving-vehicle sound,

(iii) recognize the moving vehicle is coming to a stop by the change from the moving-vehicle sound to the idling sound, and

(iv) recognize the stopped vehicle is beginning to move by the change from the idling sound to the moving-vehicle sound.

In other words, a pedestrian may know whether the vehicle is stopping, traveling, coming to a stop, or coming to a start by the sound produced by the vehicle. Therefore, a quiet vehicle may not be recognizable to a pedestrian. The above-described problematic situation may be applicable not only to the visually impaired but also to a person with no disability, especially when he/she is thinking or his/her attention is drawn to other things.

### SUMMARY

In view of the above and other problems, the present disclosure provides, for a vehicle existence notification apparatus that is disposed in a silent-engine vehicle or a no-engine vehicle. The vehicle existence notification apparatus enables the vehicle to notify a pedestrian in a surrounding area about the existence or presence of the vehicle, when the vehicle is in a traveling condition, a stopped condition, or is transitioning between a traveling condition to stop condition or stop condition to traveling condition.

The vehicle existence notification apparatus includes a sound wave generation unit for outputting a sound wave to an area outside of a vehicle, and a control unit for controlling the sound wave generation unit to generate a notification sound. The control unit generates a stopping-vehicle notification sound for notifying existence of a stopped vehicle by controlling the sound wave generation unit during a stop condition of the vehicle. The control unit further the control unit generates a moving-vehicle notification sound for notifying existence of a moving vehicle by controlling the sound wave generation unit during a travel condition of the vehicle

In such manner, a pedestrian close to the vehicle may recognize the presence of the vehicle by the notification sound generated by the sound wave generation unit. Where the notification sound may be:

(i) a simulated idling sound for when the vehicle is in a stopped condition,

(ii) a simulated moving-vehicle sound for when the vehicle is in a traveling condition,

(iii) a transitional sound that transitions from a simulated moving-vehicle sound to a simulated idling sound for when the vehicle is transitioning from a traveling condition to a stopped condition, or

(iv) a transitional sound that transitions from a simulated idling sound to a simulated moving-vehicle sound for when the vehicle is transitioning from a stopped condition to a traveling condition.

### BRIEF DESCRIPTION OF THE DRAWING

FIG. 1A is an illustration of the simulated idling sound in a first embodiment of the present disclosure;

FIG. 1B is an illustration of the simulated moving-vehicle sound in a first embodiment of the present disclosure;

FIG. 2 is a block diagram of a vehicle existence notification apparatus of the present disclosure;

FIG. 3 is an illustration of a vehicle existence notification apparatus of the present disclosure;

FIG. 4A is a cross-sectional view of the vehicle existence notification apparatus of the present disclosure;

FIG. 4B is a perspective view of the vehicle existence notification apparatus of the present disclosure;

FIG. 5 is a diagram of frequency characteristics of a vehicular horn the vehicle existence notification apparatus of the present disclosure;

FIGS. 6A, 6B, and 6C are illustrations of a method for generating a simulated idling sound of the present disclosure;

FIGS. 7A, 7B, 7C, 7D and 7E are illustrations of an operation principle of a parametric speaker;

FIGS. 8A and 8B are illustrations of outreach distribution of a notification sound of the present disclosure;

FIG. 9A is an illustration of the simulated idling sound in a second embodiment of the present disclosure; and

FIG. 9B is an illustration of the simulated moving-vehicle sound in a second embodiment of the present disclosure.

### DETAILED DESCRIPTION

A vehicle existence notification apparatus of the present disclosure is explained with reference to the drawings. It is to be noted that the following does not limit the scope of the disclosure to only the following embodiments. Further, in the following embodiments, like numbers describe like parts.

### First Embodiment

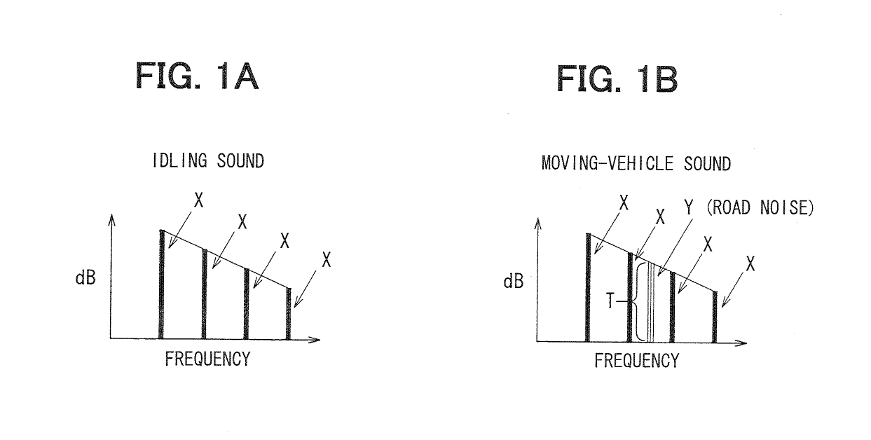

The first embodiment is described with reference to FIGS. 1 to 8.

In the present embodiment, a vehicle is equipped with the vehicle existence notification apparatus. The vehicle may be an electric vehicle that is powered by a battery or fuel cell technology or may be a hybrid car that is powered by a motor and an engine, where the engine is turned off during travel or stop of the vehicle. The vehicle is mainly a quiet vehicle that generates very little to no traveling or idling sound, and is typical not equipped with an engine.

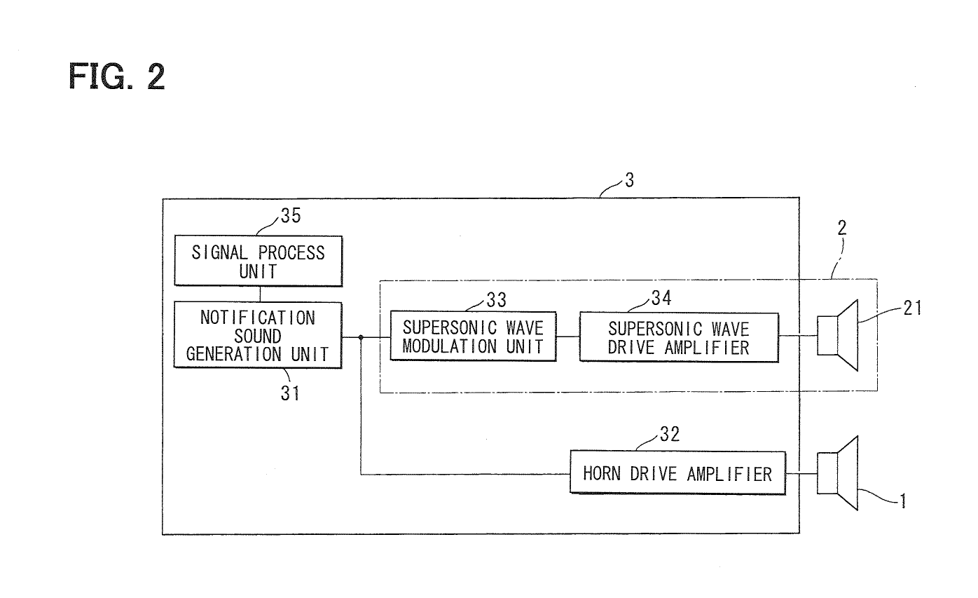

The vehicle existence notification apparatus notifies a pedestrian, such as an individual walking on or around the side of a road, of the existence or presence of the vehicle by a notification sound, which may be a simulated engine-idling sound (referred to as idling sound) or a simulated moving-vehicle sound. With reference to FIG. 2, the vehicle existence notification apparatus includes, a vehicular horn 1 that is used as a dynamic speaker, a parametric speaker 2, and a control circuit 3 for controlling an operation of the vehicular horn 1 and the parametric speaker 2.

(Vehicular Horn 1)

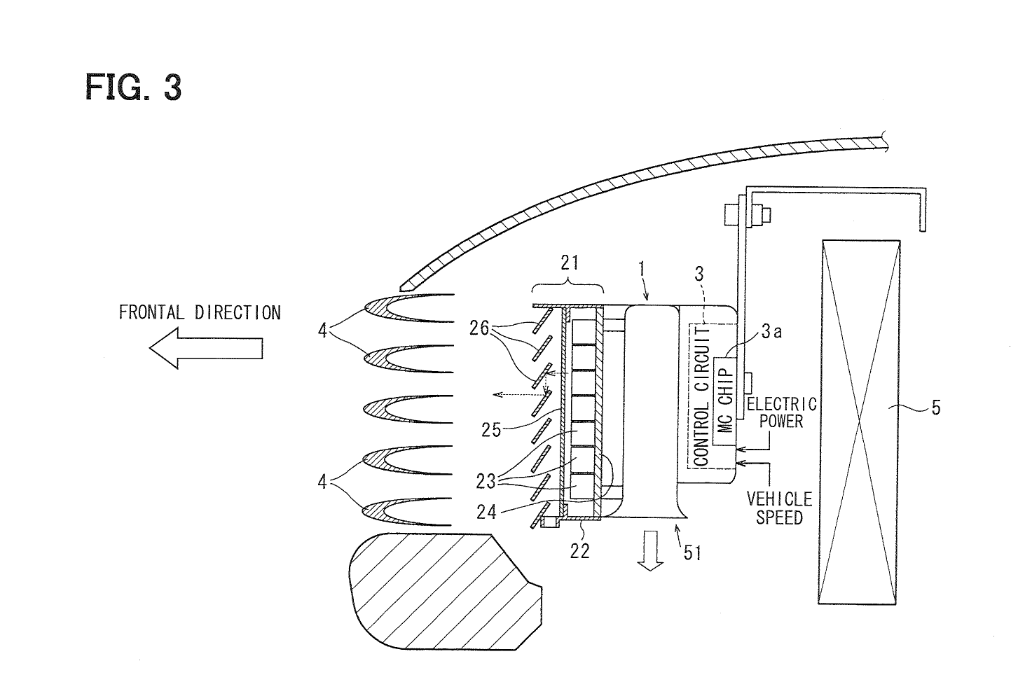

With reference to FIG. 3, the vehicular horn 1 is disposed between a front grille 4 and a heat exchanger 5. The vehicular horn 1 is an electro-magnetic type horn, and emits a warning sound when a horn switch (e.g., a horn button on a steering wheel) is operated by an occupant of the vehicle. That is, when the horn switch is engaged, the vehicular horn 1 generates a warning sound when a self-excitation voltage is above a threshold, such as 8V or more (e.g., a battery voltage).

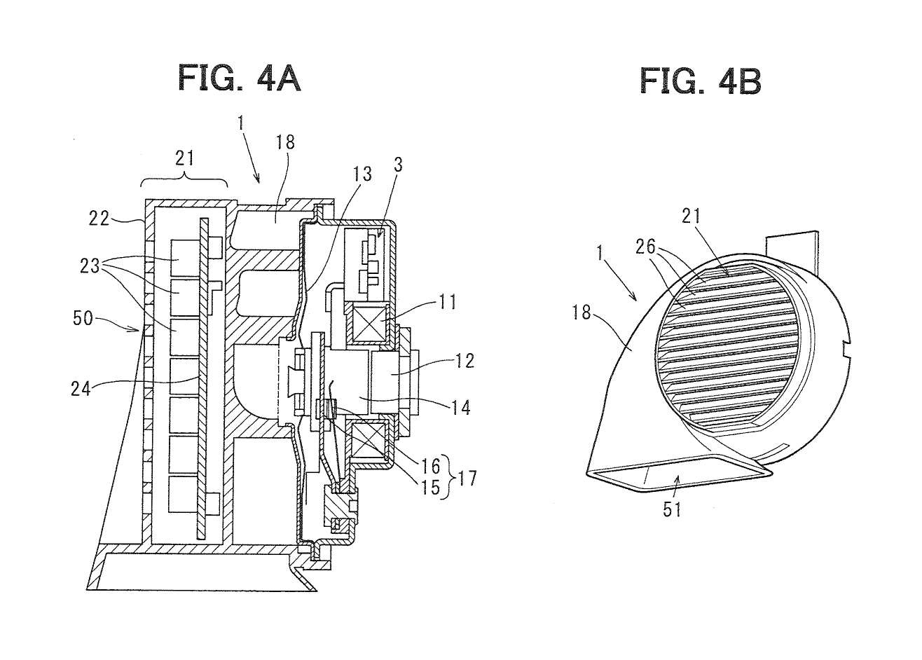

With reference to FIGS. 4A and 4B, the vehicular horn 1 is explained with reference to FIGS. 4A and 4B.

The vehicular horn 1 includes a coil 11 to generate a magnetic force, a fixed iron core 12, a movable iron core 14, a movable contact point 16, and a fixed contact point 15. The fixed iron core 12 outputs an attraction force that is generated by a magnetic force from the coil 11, and may be referred to as a magnetic attraction force.

The movable iron core 14 is supported at the center of a vibration board 13. The attraction force provided by the fixed iron core 12, moves the movable iron core 14 toward the fixed iron core 12, and as a result, the movable contact point 16 decouples from the fixed contact point 15, which interrupts the electric current supplied to the coil 11.

In particular, the self-excitation voltage is supplied across the coil 11 via power terminals that are coupled to the ends of the coil 11, and a current flows across the coil 11. When the self-excitation voltage is above the threshold (i.e. the voltage is equal to or greater than 8V), an attracting action and a returning action is repeatedly performed within the vehicular horn 1.

Specifically, in regards to the attracting action, when the current flows through the coil 11, an electromagnetic field is generated an attraction occurs between the movable iron core 14 and the fixed iron core 12, such that the movable iron core 14 moves towards the fixed iron core 12. Due to the movement of the moveable iron core 14 towards the fixed iron core 12, the moveable contact point 16 decouples from the fixed contact point 15, causing the current to stop flowing through the coil 11.

Once, the current has stopped flowing through the coil 11, the electromagnetic field is no longer generated and the movable iron core 14 returns to its initial position, which is the start of the returning action. Due to the biasing of the movable iron core 14, the movable contact point 16 couples with the fixed contact point 15, and the current resumes flowing through the coil 11, thus restarting the attracting action.

In other words, when the self-excitation voltage is equal to or greater than the threshold voltage the current flows through the coil 11, and an electric current interrupter 17, which allows and prevents the current from flowing through the coil 11, is formed by the fixed contact point 15 and the movable contact point 16.

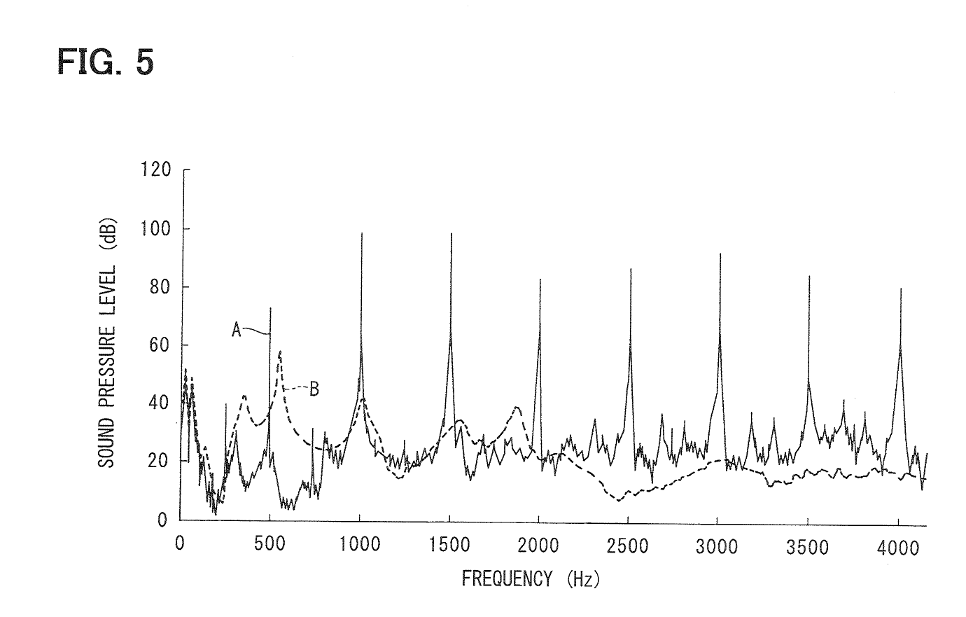

Due to the attracting and returning action, the movable iron core 14 causes a vibration of the vibration board 13, and the vehicular horn 1 generates the warning sound. That is, the vibration of the vibration board 13 is caused by the vibration of the movable iron core 14 according to an intermittent electricity supply due to the connection and disconnection of the electricity to the coil 11 (i.e., due to the generation and non-generation of the magnetic attraction force from the fixed iron core 12) in the above-described manner, and the vehicular horn 1 generates a warning sound. The frequency characteristics of the warning sound generated by the vehicular horn 1, when the self-excitation voltage is greater than or equal to 8V, is shown by a solid line A in FIG. 5.

Further, in the present embodiment, the vehicular horn 1 is operated as a dynamic speaker by providing the vehicular horn 1 a driving signal of a separate excitation voltage that is lower than the threshold voltage, such as an excitation voltage lower than 8V.

The frequency characteristic of the vehicular horn 1, at a time of using the vehicular horn 1 as a dynamic speaker, is shown by a broken line B in FIG. 5. The dashed line B shows the frequency characteristics when a sweep signal (i.e., a variable signal transiting from a low frequency to a high frequency) of 1 V in a sine wave form is provided for the vehicular horn 1.

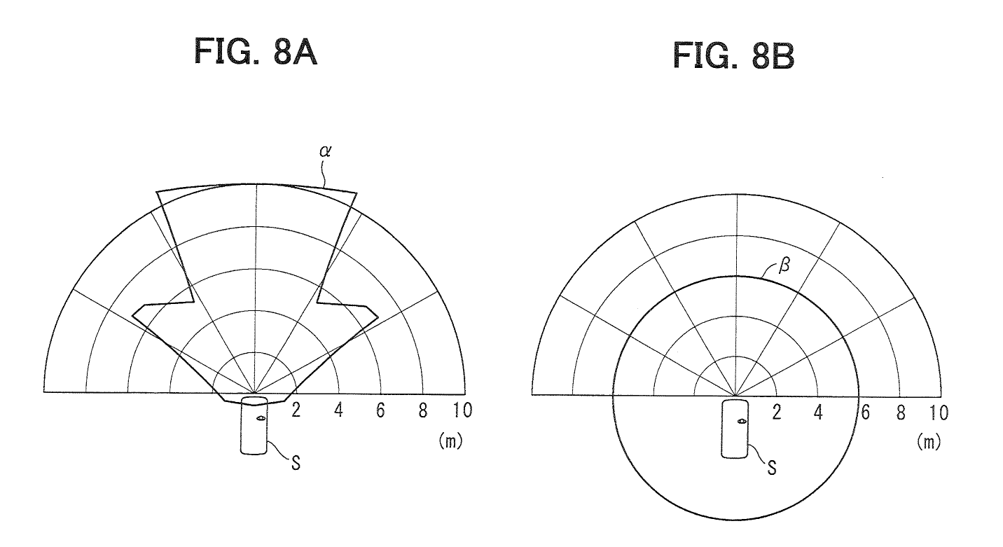

Further, the vehicular horn 1 in the present embodiment is equipped with a swirl shape horn 18 (i.e., a trumpet member in a swirling shape, or a sound tube in a swirl shape) as shown in FIG. 4B. The swirl shape horn 18 amplifies the warning sound generated by the vibration of the vibration board 13, and outputs the amplified sound outward from the vehicle to the surrounding area via a horn opening 51. The vehicular horn 1 of the present embodiment evenly distributes a sound around the vehicular horn 1 (see a solid line β of FIG. 8). Specifically, the swirl shape horn 18 of the vehicular horn 1 is arranged to have the horn opening 51 directed toward a lower part of the vehicle, facing a road surface. The direction of the opening of the swirl shape horn 18 is not limited to the downward direction. Further, the sound wave may output in any direction by using a reflector or the like.

(Parametric Speaker 2)

With reference to FIG. 4A and 4B, the parametric speaker 2 is a device that outputs, from a supersonic speaker 21, an audible sound after supersonic modulation of a wave form signal of the audible sound. The supersonic wave, which is non-audible sound, is outputted from the supersonic speaker 21, and has a modulated sound component that is to be self-demodulated during transmission in air, thereby generating an audible sound at a distant position from the supersonic speaker 21.

The supersonic wave speaker 21 used in the parametric speaker 2 is a supersonic generating device that vibrates the air at a frequency out of the audible range for a human ear (i.e., greater than 20 kHz). The supersonic wave speaker is installed in the vehicle to output the supersonic wave outward from the vehicle.

More practically, the supersonic wave speaker 21 in the present embodiment is installed in the swirl shape horn 18 of the vehicular horn 1. The supersonic wave speaker 21 is directed towards the front grille 4 (FIG. 3), which may be referred to as a frontal direction of the vehicle.

The supersonic speaker 21 in the present embodiment includes a supersonic speaker housing 22 made of resin and disposed/integrated on a side of the swirl shape horn 18, and a plurality of supersonic transducers 23 that are accommodated in the supersonic speaker housing 22.

The supersonic transducers 23 have a well-known structure including the piezoelectric elements that expand and contract according to the applied voltage (i.e., the electric voltage from charge and discharge of the electric current) and the supersonic vibration board which generates a compression air wave by the expansion and contraction of the piezoelectric elements.

The supersonic transducers 23 are all disposed on a support board 24 in the supersonic speaker housing 22 to form a speaker array.

The supersonic speaker 21 has a speaker opening 50 from which the supersonic wave from each of the supersonic transducers 23 is emitted, towards a frontal direction of the vehicle. The speaker opening 50 includes a waterproof device that prevents water from entering the supersonic transducer 23.

An example of the waterproof device in the present embodiment is a waterproof sheet 25 that covers the speaker opening 50 of the supersonic speaker 21 and a louver 26 that is disposed in front of the waterproof sheet 25 (FIG. 3).

(Control Circuit 3)

A control circuit 3 has a microcomputer chip 3a disposed on a control substrate as shown in FIG. 3, and is disposed in the vehicular horn 1, such as on an inside surface of a horn housing, as shown in FIG. 4A.

The control circuit 3 includes, as shown in FIG. 2,

(a) a notification sound generation unit 31 for generating a notification sound signal that is representative of either the simulated idling sound or the simulated traveling sound,

(b) a horn drive amplifier 32 for driving the vehicular horn 1 according to the notification sound signal,

(c) a supersonic wave modulation unit 33 for modulating the notification sound signal to a signal having a supersonic frequency,

(d) a supersonic wave drive amplifier 34 for driving the supersonic speaker 21 according to the supersonic modulated signal from the supersonic wave modulation unit 33, and

(e) a signal process unit 35 for controlling the above-described operations.

The above-described components (a) to (e) of the control circuit 3 are described in detail.

(Notification Sound Generation Unit 31)

The notification sound generation unit 31 is a well-known type computer including a CPU for arithmetic calculation, a memory for storing a program, an input circuit, an output circuit, and the like. The memory of the notification sound generation unit 31 stores a program for generating the notification sound, such as the simulated idling sound and the simulated traveling sound, based on the digital sound generation technique.

The notification sound generation unit 31 is configured to generate:

(i) a signal for generating the simulated idling sound to notify the existence of the vehicle when the vehicle is stopping, and when the signal process unit 35 provides a stop sound generation instruction,

(ii) a signal for generating the simulated moving-vehicle sound to notify the existence of the vehicle when the vehicle is traveling, and when the signal process unit provides a moving-vehicle sound generation instruction.

The signal for generating the simulated idling sound and the signal for generating the simulated moving-vehicle sound may collectively be referred to as the notification sound signal.

(Simulated Idling Sound)

An example of the signal for generating the simulated idling sound generated by the notification sound generation unit 31 is now described. The following description is only an example, and the embodiment of such signal is not limited to such example.

The notification sound generation unit 31 is a device for generating a frequency signal for generating the simulated idling sound (i.e., a wave form signal) based on a clock signal from a standard clock, such as an oscillator in the computer.

The frequency signal of the simulated idling sound is generated:

(i) when a predetermined frequency is designated as A Hz, which is provided as a howling frequency and may be a selected frequency between a predetermined range, such as 1 Hz and 10 Hz, and

(ii) multiple frequency signals having a frequency interval of A Hz are generated at the same time to reproduce a simulated idling sound.

More practically, in the present embodiment, the value of A Hz is provided as the fixed frequency of 8 Hz. Such a fixed frequency of 8 Hz is only an example, and the fixed frequency may also be 4 Hz or any other frequency value such as a frequency range between 7.5 to 8.5 Hz, 3.5 Hz to 4.5 Hz or the like, which includes a decimal point in the frequency value.

Further, the notification sound generation unit 31 has a frequency range determination unit, which is a program, to determine a frequency range that includes a plurality of frequency signals successively-arranged at a frequency interval of 8 Hz, which are used to generate the simulated idling sound and may be designated as a simulated idling sound generation band.

An example of a selection of the simulated idling sound generation band is shown in the following.

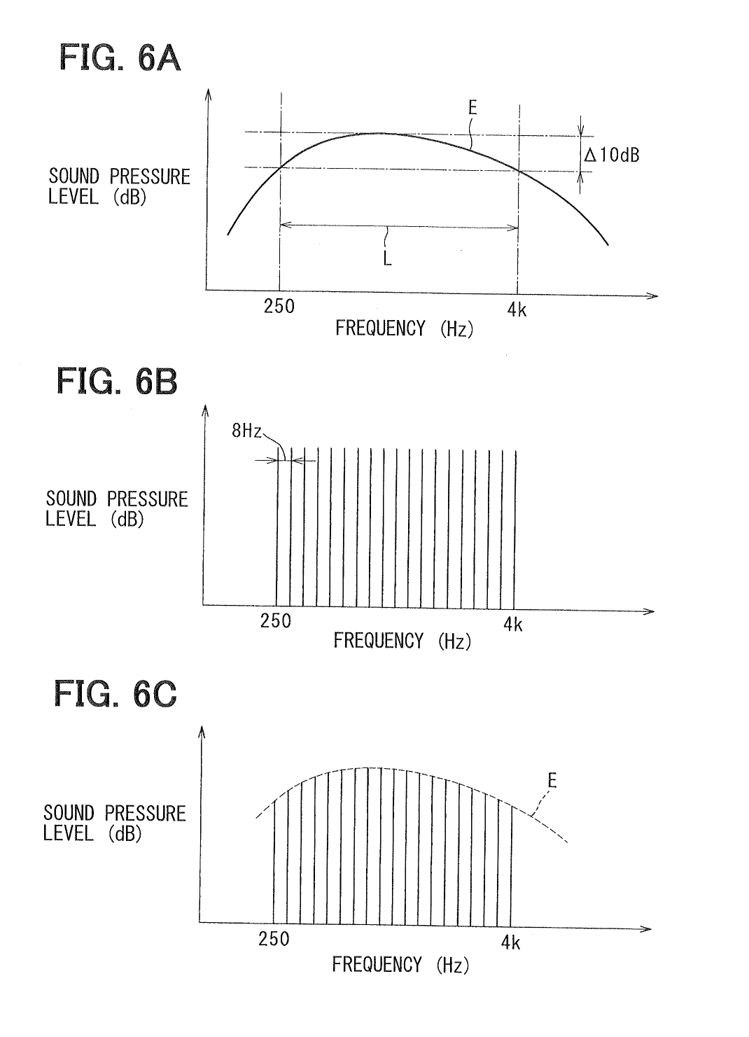

The frequency characteristics of an actual idling sound, such as an idling sound produced by a vehicle with an internal combustion engine, is shown as a solid line E in FIG. 6A. The range of sound frequency audible to the human ear is designated as a major frequency L (i.e., a range of frequency within Δ10 dB), and, in such frequency range, the sound wave has the sound pressure level between a maximum value and a value 10 dB below the maximum. In other words, the sound outside of the major frequency L has low sound pressure that can hardly be heard/recognized due to the masking effect of the sound in the major frequency range L.

Therefore, the frequency range determination unit of the notification sound generation unit 31 utilizes such dominance of the sound within the major frequency L for the human ear to generate only the major frequency L for representing many frequency signals (i.e., frequency signals for generating the simulated idling sound) successively-arranged at a frequency interval of 8 Hz, as shown in FIG. 6B.

When a simulated idling sound is created to simulate or replicate an actual idling sound of a designated vehicle, the actual idling sound of the designated vehicle is measured. Next, a frequency range of the sound having the sound pressure level between the maximum value and the value 10 dB below the maximum is determined. Such a frequency range is determined as the major frequency L, as described above. The major frequency L substantially matches a sensitive frequency range of the human ear (≅250 Hz to 4 kHz). Therefore, the notification sound generation unit 31 is configured to generate, as shown in FIG. 6B, only “250 Hz to 4 kHz (i.e., the major frequency L) to represent the frequency signals for generating the simulated idling sound.

Further, the notification sound generation unit 31 in the present embodiment has a frequency characteristic process unit, which is a program, that processes or characterizes frequency characteristics of the simulated idling sound generation band, which is the plurality of frequency signals successively-arranged at a frequency interval of 8 Hz determined by the frequency range determination unit.

Now, it is assumed that the actual idling sound of the designated vehicle has a frequency characteristic of the solid line E of FIG. 6A, which is to be simulated or replicated by the simulated idling sound.

In such a case, the frequency characteristic process unit processes each of frequency characteristics of FIG. 6B (i.e., characteristics of a sound level of many frequency signals), to generate a general form of the frequency characteristics in FIG. 6C, for simulating the actual idling sound of the certain vehicle model shown in FIG. 6A.

Further, the notification sound generation unit 31 has a void band generation unit, which is a program, for generating one or more signal void bands (i.e., a void band group) in the simulated idling sound generation band, which is made by voiding the frequency signals of 8 Hz interval, three of such signal void bands generated in FIG. 1A, for example.

By providing the signal void band in the simulated idling sound generation band, there are multiple signal groups X made of multiple frequency signals successively-arranged at a frequency interval of 8 Hz.

More practically, the signals for generating the simulated idling sound shown in FIG. 1A have three signal void bands in the simulated idling sound generation band, to have four signal groups X in the simulated idling sound generation band.

By defining the signal void band(s) to have a large ratio in the simulated idling sound generation band, a noisy feeling of the simulated idling sound can be reduced.

Further, multiple signal groups X may preferably have one of the following relationships, that is:

a harmonic overtone relationship,

musical scales chosen from among musical temperament scales, or

a chord relationship.

The notification sound generation unit 31 generates the signal for generating the simulated idling sound of FIG. 1A in the above-described manner when the stop sound generation instruction is provided from the signal process unit 35.

(Simulated Moving-Vehicle Sound)

An example of the signal for generating the simulated moving-vehicle sound generated by the notification sound generation unit 31 is explained. The following description is only an example of such signal, and the embodiment of such signal is not limited to such example.

The simulated moving-vehicle sound in the present embodiment is provided as a combination of the simulated idling sound, which is a simulated engine noise, and a simulated road noise.

The notification sound generation unit 31 of the present embodiment adds a signal for generating the simulated road noise to the signal for generating the simulated idling sound (cf. FIG. 1A) to generate the signal for generating the simulated moving-vehicle sound.

Now, an example of the signal for generating the simulated road noise is explained. In this case, the simulated road noise is a sound that is generated during a travel of the vehicle, other than the engine sound. For example, the simulated road noise may be a simulated tire noise, a simulated wind noise, a simulated stone flipping noise, or the like.

The notification sound generation unit 31 is a device for generating a frequency signal for generating the simulated road noise (i.e., a wave form signal) based on a clock signal from a standard clock (i.e., an oscillator) in the computer.

The frequency signal of the simulated road noise is generated in the following manner. That is,

(i) when a predetermined frequency is designated as B Hz, which is a selected frequency between a certain range, such as 1 Hz and 10 Hz, and

(ii) successively-arranged multiple (i.e., many) frequency signals having a frequency interval of B Hz are generated, in bundle, at the same time to reproduce a simulated road noise.

In other words, a signal group Y having frequency signals successively-arranged at a frequency interval of B Hz in a certain frequency range is used to form the simulated road noise in the present embodiment.

In such manner, when receiving the moving-vehicle sound generation instruction from the signal process unit 35, the notification sound generation unit 31 generates the signal for generating the simulated road noise generated in addition to the signal for generating the simulated idling sound, as shown in FIG. 1B.

(Horn Drive Amplifier 32)

The horn drive amplifier 32 is a power amplifier to operate the vehicular horn 1 as a dynamic speaker. The horn drive amplifier 32 amplifies the notification sound signal provided by the notification sound generation unit 31. The horn drive amplifier 32 outputs the amplified signal to the power terminals of the coil 11 of the vehicular horn 1.

Further, when the vehicular horn 1 is used to generate the notification sound, the horn drive amplifier 32 controls the voltage supplied to the coil 11 to a voltage less than the threshold voltage, such as a voltage less than 8 V. By restricting the voltage supplied to the coil 11, the horn drive amplifier prevents the vehicular horn 1 from producing the warning sound.

(Supersonic Wave Modulation Unit 33)

The supersonic wave modulation unit 33 performs a supersonic modulation on the notification sound signal provided by the notification sound generation unit 31.

In the present embodiment, the supersonic wave modulation unit 33 performs an amplitude modulation (AM) on the notification sound signal to generate a signal of amplitude change (i.e., an increase and a decrease of the electric voltage) at a supersonic frequency, such as of 25 kHz or the like.

Further, the supersonic wave modulation unit 33 may perform, a pulse width modulation (PWM) for modulating the notification sound signal to generate a sound wave having a pulse width change (i.e., change in pulse generation time) at a certain supersonic frequency, or may perform other modulation techniques for generating a supersonic wave.

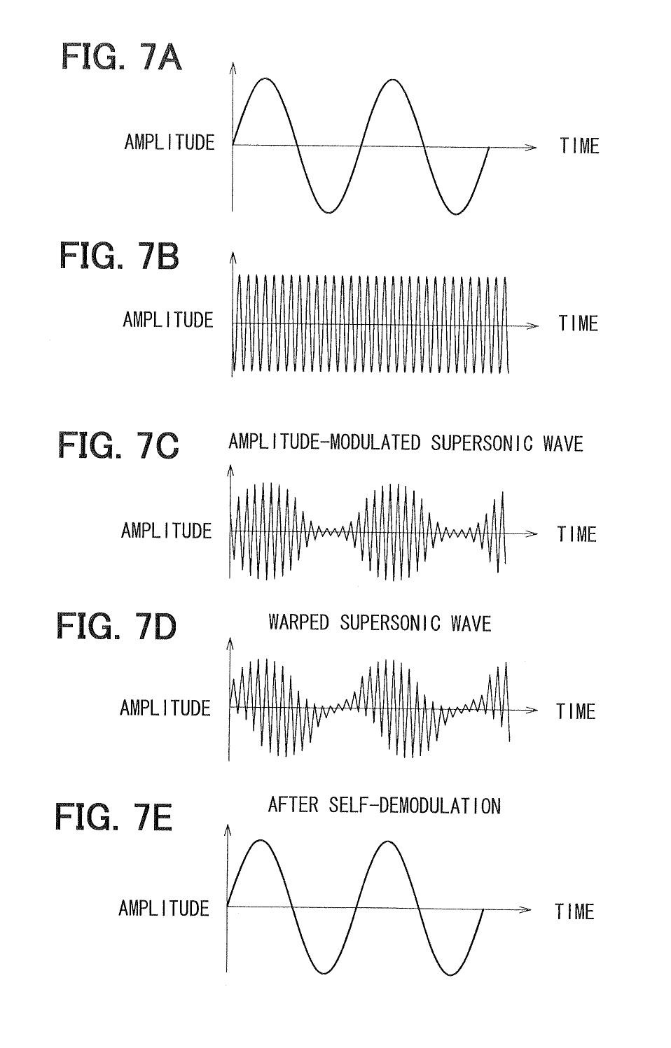

An example of the supersonic modulation by the supersonic wave modulation unit 33 is explained with reference to FIGS. 7A to 7E. By way of example, it is assumed that the notification sound signal provided to the supersonic wave modulation unit 33 has a voltage change having a wave form shown in FIG. 7A. A wave form of the single frequency is shown for the ease of understanding, but the sound wave may not necessarily be limited to such single frequency.

A supersonic wave oscillator in the control circuit 3 is assumed to oscillate at a supersonic frequency shown in FIG. 7B.

In FIG. 7C, the supersonic wave modulation unit 33 performs the following,

(i) as the signal voltage of the frequency to generate a notification sound signal increases, the supersonic wave modulation unit 33 increases the amplitude of the voltage of the supersonic wave vibration, and

(ii) as the signal voltage of the frequency to generate a notification sound signal decreases, the supersonic wave modulation unit 33 decreases the amplitude of the voltage of the supersonic wave vibration

In the above-described manner, the supersonic wave modulation unit 33 modulates the notification sound signal that is output from the notification sound generation unit 31 into the amplitude change of the oscillation voltage at the supersonic wave frequency.

(Supersonic Wave Drive Amplifier 34)

The supersonic wave drive amplifier 34 drives each of the supersonic transducers 23 based on the supersonic wave signal that is modulated by the supersonic wave modulation unit 33. That is, the supersonic wave drive amplifier 34 generates the supersonic wave, which is formed by the modulation of the notification sound signal by controlling the applied voltage for (i.e., charging and discharging conditions of) each of the supersonic transducers 23.

(Signal Process Unit 35)

Based on drive information of the vehicle from an electronic control unit (ECU) installed in the vehicle, the signal process unit 35 provides,
(i) the stop sound generation instruction to the notification sound generation unit 31 when a current driving condition of the vehicle is determined to be stopped, such as in a situation in which the stopping of the vehicle is preferably represented by a simulated sound, or
(ii) the moving-vehicle sound generation instruction to the notification sound generation unit 31 when a current driving condition of the vehicle is determined as traveling, such as in a situation in which the moving of the vehicle is preferably represented by a simulated sound (e.g., when the vehicle is traveling at a speed under a certain value, such as 20 km/h or the like).

The vehicle may be considered to be in a stop or stopping condition when the vehicle stands still (i.e. it is completely stopped). The vehicle may be considered to be in a traveling condition when the speed of the vehicle is within a predetermined range.

(Operation of the Vehicle Existence Notification Apparatus)

When the signal process unit 35 provides the stop sound generation instruction to the notification sound generation unit 31 during a vehicle stop, the notification sound generation unit 31 outputs the notification sound signal as a signal for generating the simulated idling sound.

When the signal process unit 35 provides the moving-vehicle sound generation instruction to the notification sound generation unit 31 during a travel of the vehicle, the notification sound generation unit 31 outputs the notification sound signal as a signal for generating the simulated moving-vehicle sound, which is provided as a signal for generating the simulated road noise plus a signal for generating the simulated idling sound.

As shown in FIG. 7C, the supersonic wave speaker 21 emits a supersonic wave that is a modulation of the notification sound signal, which may be a signal for generating the simulated idling sound or a signal for generating the simulated moving-vehicle sound.

Then, as the supersonic wave travels in the air, the supersonic wave having a short wavelength is warped by a viscosity of the air, or the like (FIG. 7D). That is, the edge of the supersonic wave dulls, due to the attenuation of the wave energy.

As a result, as shown in FIG. 7E, an amplitude component in the supersonic wave is self-demodulated during the travel of the supersonic wave, thereby reproducing the notification sound that may be the simulated idling sound or the simulated moving-vehicle sound in front of the vehicle at a position that is distant from a source of the supersonic wave (i.e., at a distant position from the vehicle having the supersonic speaker 21).

A coverage area of the notification sound from the parametric speaker 2 is shown in a solid line α in FIG. 8A. The vehicle in FIG. 8A is represented by a sign S, and the coverage area surrounded by the solid line α shows an area of the notification sound with its sound pressure measured as 50 dB or greater.

The vehicular horn 1 generates the notification sound, which may be the simulated idling sound or the simulated moving-vehicle sound, according to the notification sound signal from the notification sound generation unit 31, where the notification sound signal may be a signal for generating the simulated idling sound or a signal for generating the moving-vehicle sound, which is provided as a signal for generating the simulated road noise plus a signal for generating the simulated idling sound.

A coverage area of the notification sound from the vehicular horn 1 is shown in a solid line β in FIG. 8B. The coverage area surrounded by the solid line β shows an area of outreach of the notification sound with its sound pressure measured as 50 dB or greater.

(Advantageous Effects Observed in the First Embodiment)

The vehicle existence notification apparatus of the present embodiment generates from the vehicular horn 1 and from the parametric speaker 2 a notification sound provides as:

a simulated idling sound to notify the existence of the vehicle when it is stopped or standing still, and

a simulated moving-vehicle sound, which includes a simulated idling sound plus a simulated road noise, to notify the existence of the vehicle when the vehicle is moving or traveling, where the travel of the vehicle is at a speed that is lower than a predetermined threshold value.

In addition, the vehicle existence notification apparatus of the present embodiment is configured to:

(i) smoothly change the notification sound to notify the existence of the vehicle that is stopped, which is provided as the simulated idling sound, to a notification sound to notify the existence of the vehicle when the vehicle begins to accelerate from the stopped condition, which is the simulated moving-vehicle sound (i.e. when the vehicle goes from a stopped condition to a travel/move condition), and

(ii) smoothly change a notification sound to notify the existence of the vehicle that is traveling, which is provided as the simulate moving-vehicle sound, to a notification sound to notify the existence of the vehicle when it is stopped, which is the simulated idling sound, (i.e. when the vehicle goes from a travel/move condition to a stop condition).

More practically, the notification sound generation unit 31 of the present embodiment is configured to add, to a simulated idling sound, a simulated road noise having the sound pressure according to the speed of the vehicle.

That is, a sound pressure level T of the simulated road noise is increased as the speed of the vehicle increases, and the sound pressure level T of the simulated road noise is decreased as the speed of the vehicle decreases (FIG. 1B). Further, when the moving vehicle stops, the simulated road noise smoothly disappears in synchronization with the stop of the vehicle.

Therefore, the change, or the switching, between a simulated idling sound to notify the existence of the vehicle in a stop condition and a simulated moving-vehicle sound to notify the existence of the vehicle in a travel/move condition is synchronized with the actual stop and start of the vehicle.

Therefore,

(i) the pedestrian can recognize the existence of a stopped vehicle by a simulated idling sound, and

(ii) the pedestrian can recognize the existence of a moving vehicle by a simulated moving-vehicle sound, and

(iii) the pedestrian can recognize the stop of a moving vehicle by the change of the sound transitioning from the simulated moving-vehicle sound to the simulated idling sound, and

(iv) the pedestrian can recognize the start of a stopped vehicle by the change of the sound transitioning from the simulated idling sound to the simulated moving-vehicle sound.

### Second Embodiment

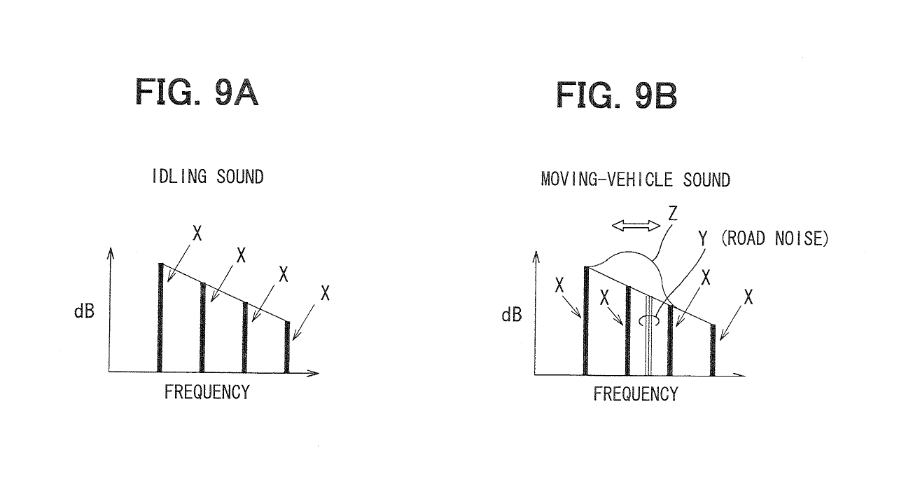

The second embodiment is explained with reference to FIG. 9. Like parts have like numbers in the second embodiment as the first embodiment.

In the first embodiment, the simulated moving-vehicle sound is generated by adding the simulated road noise to the simulated idling sound.

In contrast, in the present embodiment, a frequency characteristic of the simulated idling sound shown in the first embodiment is changed depending on the travel condition of the vehicle (e.g., a vehicle speed, an accelerator opening and the like). In other words, a simulated moving-vehicle sound is represented by a simulated engine sound that changes depending on the travel condition of the vehicle in the second embodiment.

More practically, the notification sound generation unit 31 in the present embodiment uses the following scheme:

(i) as the vehicle speed increases, the height of a peak of a curve Z representing a frequency characteristic of the simulated idling sound is raised by the frequency characteristic process unit (see the first embodiment), and the position of the peak of the curve Z is moved toward a high tone side, and

(ii) as the vehicle speed decreases, the height of the peak of the curve Z of the frequency characteristic of the simulated idling sound is lowered by the frequency characteristic process unit, and the position of the peak of the curve Z is moved toward the low tone side.

Further, at a time of stop of a moving vehicle, the curve Z of the frequency characteristic is configured to smoothly match with the simulated idling sound.

In such manner, by changing the curve Z of the frequency characteristic of the simulated idling sound depending on the travel condition of the vehicle, the notification sound from the vehicle existence notification apparatus is made closer to an actual sound of an engine, thereby diminishing the strangeness feeling regarding the notification sound generated by the vehicle existence notification apparatus.

### Modification of the Second Embodiment

In the present embodiment, by changing the curve Z of the frequency characteristic depending on a travel condition of the vehicle, the authenticity of the sound emitted from the vehicle, which is a quiet vehicle, is improved to accurately replicate an actual sound produced by a vehicle that has an engine. The A Hz, i.e., the frequency interval of the howling, in the first embodiment may be successively or step-wisely changed depending on the travel condition of the vehicle, to make the simulated engine sound closer to the actual engine sound.

Further, the technique to change the curve Z of the frequency characteristic depending on the travel condition of the vehicle and the technique to change the A Hz, i.e., the frequency interval of howling, depending on the travel condition of the vehicle in the first embodiment may be combined.

In the embodiment described above, the present disclosure is applied, for example, to a vehicle such as a battery car, a fuel cell-powered car, a hybrid car, which can travel with an electric motor. However, the present disclosure may be used in an engine vehicle (i.e., a conventional vehicle) equipped with an idling stop function, or, even if the engine vehicle is not equipped with the idling stop function, the present disclosure may be applied to a quiet vehicle which generates little/no engine sound, for the improvement of the vehicle safety.

In the embodiment described above, the simulated idling sound is generated by both of the parametric speaker 2 and the dynamic speaker (i.e., the vehicular horn 1 in the above embodiment). However, the simulated idling sound may be generated by only one of the parametric speaker 2 and the dynamic speaker.

In the embodiment described above, the simulated idling sound is used as an example of a notification sound to notify the existence of a stopped vehicle. However, other sounds may also be used, without limitation, as the notification sound to notify the existence of the stopped vehicle, as long as the sound is capable of notifying the existence of the stopped vehicle.

In the embodiment described above, the simulated moving-vehicle sound is used as an example of a notification sound to notify the existence of the moving vehicle. However, other sounds may also be used, without limitation, as the notification sound to notify the existence of the moving (i.e., traveling) vehicle, as long as the sound is capable of notifying the existence of the moving (i.e., traveling) vehicle.

Based on the foregoing, the vehicle existence notification apparatus notifies the existence of the vehicle by a notification sound. The vehicle existence notification apparatus includes a sound wave generation unit, which maybe provided as the parametric speaker 2 and the dynamic speaker (i.e. vehicular horn 1), to output a sound wave (i.e. a notification sound) toward an area outside of the vehicle, and the control circuit 3 to generate the notification sound from the sound wave generation unit. The control circuit 3 is configured to generate a notification sound to notify the existence of the stopped vehicle (e.g., a simulated idling sound) from the sound wave generation unit during the stop of the vehicle, and to generate a notification sound to notify the existence of the moving vehicle (e.g., a simulated moving-vehicle sound) from the sound wave generation unit during the travel of the vehicle.

Additionally, the control circuit 3 of the vehicle existence notification apparatus changes a notification sound to notify the existence of the stopped vehicle to a notification sound to notify the existence of the moving vehicle. In such manner, the stop of a moving vehicle and the start of a stopped vehicle are notified to a pedestrian with a natural sound that replicates the actual sound generated by a vehicle with an engine.

The vehicle existence notification apparatus notifies the existence of the stopped vehicle by using the simulated idling sound, thereby enabling a notification of the stopping vehicle to a pedestrian who has no prior knowledge about the notification sound to notify the existence of the stopping vehicle.

Further, the vehicle existence notification apparatus notifies the existence of the moving vehicle by a simulated engine sound changing according to a travel condition of the vehicle (i.e., a vehicle speed, an accelerator opening, and the like), thereby enabling a notification of the moving vehicle to a pedestrian who has no prior knowledge of a notification sound to notify the existence of the moving vehicle

Further, the vehicle existence notification apparatus notifies the existence of the moving vehicle by a simulated road noise, such as a tire noise, a wind noise, a stone flipping noise or the like, thereby enabling a notification of the moving vehicle to a pedestrian who has no prior knowledge of a notification sound to notify the existence of the moving vehicle.

Although the present disclosure has been fully described in connection with preferred embodiment thereof with reference to the accompanying drawings, it is to be noted that various changes and modifications will become apparent to those skilled in the art.

Changes, modifications, and summarized schemes are to be understood as being within the scope of the present disclosure as defined by appended claims.

What is claimed is:

1. A vehicle existence notification apparatus comprising:
a sound wave generation unit for outputting a sound wave to an area outside of a vehicle; and
a control unit for controlling the sound wave generation unit to generate a notification sound, wherein
the control unit generates a stopping-vehicle notification sound for notifying existence of a stopping vehicle by controlling the sound wave generation unit during a stop of the vehicle, and
the control unit generates a moving-vehicle notification sound for notifying existence of a moving vehicle by controlling the sound wave generation unit during a travel of the vehicle.

2. The vehicle existence notification apparatus of claim 1, wherein
the control unit transitions from the stopping-vehicle notification sound to the moving-vehicle notification sound when the stopping vehicle starts to move, and
the control unit transitions from the moving-vehicle notification sound to the stopping-vehicle notification sound when the moving vehicle comes to stop.

3. The vehicle existence notification apparatus of claim 1, wherein
the stopping-vehicle notification sound is a simulated idling sound, and
the moving-vehicle notification sound is a simulated engine sound that changes according to a travel condition of the vehicle.

4. The vehicle existence notification apparatus of claim 1, wherein
the stopping-vehicle notification sound is a simulated idling sound, and
the moving-vehicle notification sound is a simulated sound that has a simulated road noise added thereto.

5. The vehicle existence notification apparatus of claim 4, wherein
the simulated idling sound is generated as successively-arranged multiple frequency signals having a predetermined frequency interval, which are in a form of multiple signal groups.

6. The vehicle existence notification apparatus of claim 4, wherein
the simulated road noise is generated as successively-arranged multiple frequency signals having a predetermined frequency interval.
